(19) United States
(12) Patent Application Publication
(10) Pub. No.: US 2025/0173457 A1
(43) Pub. Date: May 29, 2025

(54) METHODS, TERMINAL AND SERVER FOR MANAGING PERSONAL DATA

(71) Applicant: PIGNELA CAPITAL SA, Lausanne (CH)

(72) Inventor: Nicolas REFFE, SOREDE (FR)

(73) Assignee: PIGNELA CAPITAL SA, Lausanne (CH)

(21) Appl. No.: 18/858,299

(22) PCT Filed: Mar. 31, 2023
(86) PCT No.: PCT/FR2023/050465

§ 371 Date: Oct. 18, 2024

(30) Foreign Application Priority Data
Apr. 20, 2022 (FR) FR2203641

(51) Int. Cl. G06F 21/62; G06F 21/60; H04L 9/00; H04L 9/08; H04L 9/32

(52) U.S. Cl. CPC G06F 21/6245; G06F 21/602; H04L 9/0872; H04L 9/3297; H04L 9/50

(57) ABSTRACT

The invention relates to a process for constitution of a history of personal data of a user and is carried out by a terminal of the user. The process includes a step for obtaining a symmetric encryption key associated with a profile of the user. The process includes a step for collecting personal data of the user. Throughout the collection of these personal data a step for encryption of these personal data with the symmetric encryption key of this user. Throughout the collection of these personal data a recording step, in a general database, of blocks including the encrypted data. The blocks being organised according to a blockchain constituting a sub-graph of a general graph whereof the topology is defined by a preset data model. A root block of the sub-graph being associated with a dynamic non-fungible token of this user.

### PRIOR ART

The invention relates to the general field of the protection and management of personal data of users in a telecommunications network.

In this document, the ‘notion of personal data’ is to be understood in the widest sense and refers to any item of data over which a user wishes to retain control.

By way of non-limiting examples, the identity or the address of a physical person, the data from a banking transaction carried out by a physical or moral person, a message exchanged over a telecommunications network, geolocation data of an individual, photographs or videos acquired by an individual or received from a third party, a digital contract constitute personal data in terms of the invention.

In the current state of the art, the personal data of a user are generally managed by service providers the user subscribes to.

For example, for a user owning a bank account and a social network account it is usual for the user to provide both personal data to the banking organisation and also personal data to the operator of the social network.

This results in the user having control over his personal data, since it is very difficult for him to determine the processing carried out on these data by the service providers.

### EXPLANATION OF THE INVENTION

According to a first aspect, the invention relates to a process for constitution of a history of personal data of a user, this process being executed by a terminal of the user and comprising:
a step for obtaining a symmetric encryption key associated with a profile of the user;
a step for collecting personal data of the user;
throughout the collection of said personal data of the user:
   (i) a step for encryption of these personal data with the symmetric encryption key of the user; and
   (ii) a recording step, in a general database, of blocks comprising said encrypted data, said blocks being organised according to a blockchain constituting a sub-graph of a general graph whereof the topology is defined by a preset data model, a root block of said sub-graph being associated with a cryptographic datum specific to this user.

According to a second aspect, the invention relates to a management process, executed by a computer system, for managing the personal data of a plurality of users, this process comprising the management of a general database in which blocks are recorded, each block comprising said personal encrypted data of a said user, said blocks comprising the personal encrypted data of the same user being organised according to a blockchain constituting a sub-graph of the same general graph whereof the topology is defined by a preset data model, a root block of said sub-graph being associated with a cryptographic datum specific to this user.

In an embodiment, the cryptographic datum associated with a user is a dynamic non-fungible token of this user.

In another embodiment, the cryptographic datum associated with a user is the public key of a digital wallet (digital wallet) of this user.

In this way, and in general, the invention proposes storing a history of the personal data of users in a blockchain and linking the history of the personal data to a cryptographic datum specific to this one user, for example to a dynamic non-fungible token of this user or to the public key of a digital wallet kept by this user. In terms of the invention, users can especially be physical or moral persons.

Hereinbelow ‘digital wallet’ means a material device or secure storage and management software of digital files in the broadest sense and of digital files associated uniquely with one user, such as units of cryptocurrency and/or non-fungible tokens. In this respect, a digital wallet comprises a public key associated with the user. Such a digital wallet can for example enable electronic transactions with another party when exchanging units of cryptocurrency.

In this way, in keeping with the invention a cryptographic datum specific to a user, for example a dynamic non-fungible token or the public key of a digital wallet, points to the input node of a graph representing the history of the personal data of this user (or user) according to mapping defined by the preset data model.

The fact of linking all the personal data in a block graph, due to its probative value, ensures the immutability of the history of these data. Also, when the cryptographic datum is a dynamic non-fungible token, the invention ensures that the user remains owner of all of his past and future personal data once they are integrated into the blockchain.

The act of linking all the personal data of a user to a cryptographic datum specific to the user also lets a user ensure portability of his data in heterogeneous environments and considerably simplifies access of this user to new services.

In fact, when knowledge about a user (KYC, ‘Know Your Customer’) has been obtained via verification of documents of this user associated with a cryptographic datum (dynamic non-fungible token, public key of a digital wallet) in a first environment (for example verification of identity, credentials, eligibility, . . . ) for a first service (for example on opening a bank account) and the proof of the result of this verification is integrated into the data associated with this cryptographic datum, in a second environment obtaining this cryptographic datum directly attributes rights to this user for a second service (reservation of a vehicle for example), without restarting verification of his documents.

The invention proposes using the cryptographic datum specific to a user as element of proof of the identity of the user. When the cryptographic datum is a non-fungible token this datum also presents the characteristics of being non-repudiable and unfalsifiable. The non-fungible character of the token also ensures that this property title cannot (contrary to a digital signature for example) be reproduced or utilised unknown to the user.

The use of a cryptographic datum specific to the user (non-fungible token, public key of digital wallet) in the invention tracks the activity of a physical or moral person irrespective of environment. For example, if a cryptographic datum, especially a non-fungible token, is held by a media organisation (moral person) and the digital contents produced by this media organisation are recorded in the general graph associated with this cryptographic datum, it is very simple, regardless of environment, to prove that one of these digital contents comes from this media organisation.

In the implementation, the proof of ownership constituted by a cryptographic datum specific to the user can be managed either explicitly with visible identity of the user as physical or moral person, or totally anonymously. A user can circulate digital information linked to a cryptographic datum (non-fungible token, public key of digital wallet, . . . ) anonymously, the third party however being able verify that this information is definitely associated with this cryptographic datum.

In an embodiment, the blockchain is a distributed register within a peer network, the terminal being a peer of said network configured to store locally at least one part of said sub-graph, said blocks being stored in a local database of said terminal.

The constitution and consultation of the history of personal data of a user via the terminal of this user can be done asynchronously, off-grid, and be resynchronised without degradation of functionalities and of the security of the solution.

In an embodiment, the data model defines how branches of said sub-graph comprise blocks whereof the personal encrypted data correspond to timestamped geolocation data of said terminal during detected displacement of said terminal.

In this embodiment of the invention, the terminal of a user detects displacements. When a new displacement is detected a new branch is created in the sub-graph of the user, blockchains comprising timestamped encrypted geolocation data are integrated into the branch throughout displacement and when the position of the terminal is detected unchanged during a predetermined period, the branch stops.

In an embodiment, the data model defines how blocks whereof the personal encrypted data correspond to a digital activity of the terminal on a given date or to data received from a third party on a given date is attached, in the sub-graph of the user, to a block whereof the personal encrypted data correspond to geolocation data of said terminal timestamped on said given date.

This embodiment advantageously dates and locates all the digital activities of a user. By way of example, it ensures that a photograph acquired by the terminal of a user has been acquired on a given date and while the terminal was at a given place.

In a particular embodiment of the invention, the personal geolocation data can be associated with elements of proof of the presence of the terminal at the given position at an instant, these elements of proof being for example elements of proof signed and supplied by an operator of telecommunications capable of validating these elements by demarcation.

In an embodiment, the process of constituting personal data of a user comprises a step of integration into the sub-graph of a user, of a digital contract to which this user is party, the contract being encrypted by a public key of the terminal of the user, a public key of at least one other party to the contract and a public key of a digital trust environment, said contract comprising at least:
the symmetric encryption key of the user encrypted with a public key of the digital trust environment; and
instructions able to be executed by said digital trust environment for:
   (i) decrypting at least some of said personal data of the user with the symmetric encryption key;
   (ii) verifying that the cryptographic datum specific to the user associated with the root block of the sub-graph belongs to said user;
   (iii) analysing said deciphered personal details; and
   (iv) providing a result of said analysis to at least one party to the contract.

In this embodiment of the invention, the process for management of personal data of a plurality of users comprises a step for management of a set of instances of a digital trust environment, a said instance being configured to:
execute instructions defined in a digital contract to analyse some of the personal data of at least one said user party to the contract, said contract comprising a symmetric encryption key of said at least one party to the contract encrypted with a public key of said instance of the digital trust environment, said symmetric encryption key able to be utilised by said instance to decrypt said personal data to be analysed;
provide a result of said analysis to at least one party to the contract.

According to this aspect, the invention proposes that the contracts which analyse the personal data of users are executed in an environment of trust, and not by the terminals of the parties to the contract so as not to expose the personal data of these parties. The execution in an environment of trust is also known to the skilled person by the expression ‘Confidential computing’.

In a preferred embodiment, these contracts integrate access delegations to the personal encrypted data for exclusive use of the environment of trust wherein these data are analysed, this environment of trust being configured to decrypt all or some of the personal data of a party to the contract, analyse them and transmit the results of the analysis to one or more parties to the contract.

This embodiment of the invention advantageously allows execution of contracts between parties having heterogeneous environments. The invention in particular allows portability of the data of a user in the Metaverse (registered mark), including execution, in the Metaverse, of digital contracts needing analysis of the personal data of the parties to the contract and ensuring protection of these personal data.

In an embodiment, when the cryptographic datum specific to a user is a dynamic non-fungible token, the process of constitution of a history of personal data comprises a step for generation of at least one second dynamic non-fungible token for said user and a step for association of a sub-graph of said sub-graph with said second dynamic non-fungible token.

The user owner of the dynamic non-fungible token to which the root of the sub-graph is attached comprising the history of his personal data can generate tokens pointing to a sub-part of this sub-graph, for example on a branch of this sub-graph.

This characteristic advantageously lets the user exploit a part of his history separately.

Another aim of the invention is a terminal comprising a processor configured to carry out:
a step for obtaining a symmetric encryption key associated with a profile of the user;
a step for collecting personal data of the user; and
throughout the collection of said personal data of the user:
   (i) a step for encryption of these personal data with the symmetric encryption key of this user; and
   (ii) a recording step, in a general database, of blocks comprising said encrypted data, said blocks being organised according to a blockchain constituting a sub-graph of a general graph whereof the topology is defined by a preset data model, a root block of said sub-graph being associated with a cryptographic datum specific to this user (dynamic non-fungible token, public key of digital wallet).

Another aim of the invention is a server for management of personal data of a plurality of users, this server comprising a processor configured to manage a general database in which blocks are recorded, each block comprising personal encrypted data of a user, the blocks comprising the personal encrypted data of the same user being organised according to a blockchain constituting a sub-graph of the same general graph whereof the topology is defined by a preset data model, a root block of said sub-graph being associated with a cryptographic datum specific to this user.

The general database utilised in the invention can be centralised (for example administered by the server for management of personal data) or distributed.

Another aim of the invention is a computer program on a recording medium, this program being likely to be run on a computer. This program comprises instructions adapted to executing a process for constitution of a history of personal data such as described above.

Another aim of the invention is a computer program on a recording medium, this program being likely to be run on a computer. This program comprises instructions adapted to execute a process for management of personal data of a set of users such as described above.

Each of these programs can utilise any programming language, and can be in the form of source code, object code, or intermediate code between source code and object code, such as in a partially compiled form, or in any other preferable form.

Another aim of the invention is an information medium or a recording medium legible by a computer, and comprising instructions of the first or of the second or of the third computer program such as mentioned above.

The information or recording media can be any entity or device capable of storing the programs. For example, the media can comprise storage means such as a ROM, for example a CD ROM or a ROM of microelectronic circuit, or even magnetic recording means, for example a hard drive, or a flash memory.

On the other hand, the information or recording media can be transmittable media such as an electric or optic signal which can be conveyed via an electrical or optic cable, via radio link, wireless optic link or by other means.

The programs according to the invention can be downloaded in particular over a network of Internet type.

Alternatively, each information medium or recording medium can be an integrated circuit into which a program is incorporated, the circuit being adapted to execute or to be used in the execution of one of the processes according to the invention.

### BRIEF DESCRIPTION OF DRAWINGS

Other characteristics and advantages of the present invention will emerge from the following description in reference to the attached drawings which illustrate an exemplary embodiment devoid of any limiting character, in which:

FIG. 1 illustrates terminals, a server for management of personal data and instances of a digital trust environment able to be utilised in a particular embodiment of the invention;

FIG. 2A illustrates a general graph able to be implemented in a particular embodiment of the invention;

FIG. 2B illustrates a sub-graph of the general graph of FIG. 2A;

FIG. 3A illustrates a proposal of contract set up by a first party;

FIG. 3B illustrates a contract formed after acceptance of the proposal of contract of FIG. 3A by a second party;

FIG. 4 illustrates the setting up of a user account in a particular embodiment of the invention;

FIG. 5 illustrates the main steps performed for constitution of the history of personal data of a user;

FIG. 6 illustrates the main steps performed by the terminal of a user for consultation of personal data of this user;

FIG. 7 illustrates the main steps performed for setting up a contract;

FIG. 8 illustrates the main steps performed for execution of a contract;

FIG. 9 illustrates the material architecture of a terminal in keeping with a particular embodiment of the invention; and

FIG. 10 illustrates the material architecture of a server in keeping with a particular embodiment of the invention;

### DESCRIPTION OF EMBODIMENTS

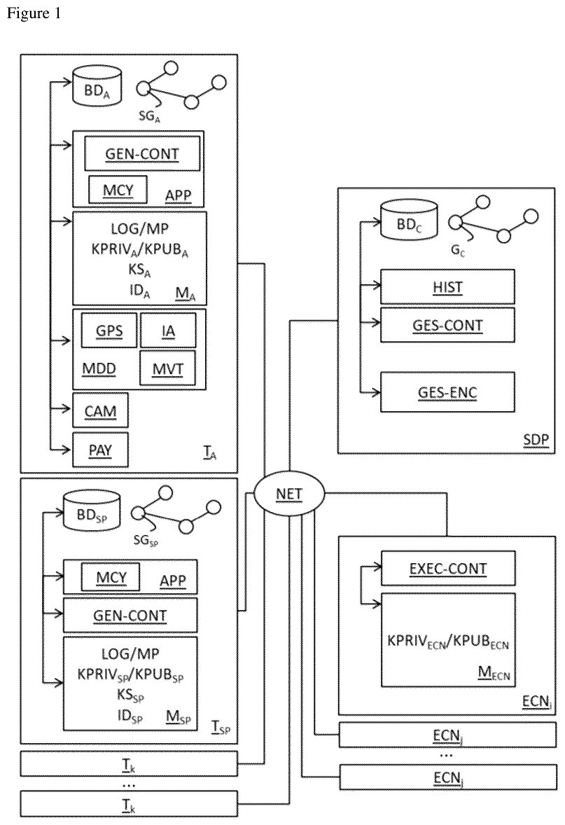

FIG. 1 illustrates the terminal T_{A} of a user A, the terminal Tsp of a service provider SP, a server SDP for management of personal data of a plurality of users and instances ECNᵢ of a digital trust environment ECN interconnected by a telecommunications network NET.

In the embodiment described here, the server SDP for management of personal data is configured to offer:
a historical data service HIST of personal data; and
a GES-CONT service for management of digital contracts using all or some of these personal data.

As described in detail hereinbelow, the historical data service HIST of personal data lets a user who subscribes to this service constitute and maintain, from his mobile terminal, a history of his personal data, to give this history a probative value and ensure its portability by linking this history to a dynamic non-fungible token as property of this user.

The GES-CONT service for management of contract executes, in a digital trust environment ECN, a digital contract passed between at least two parties, without exposing the personal data of these parties. In this respect, and as described later, the digital contracts managed by the invention integrate delegated access to the personal data of the user for the digital trust environment ECN.

In the embodiment described here, the server SDP for management of personal data also comprises a module GES-ECN for management of this digital trust environment ECN.

This digital trust environment ECN constitutes a protected environment (Trusted Execution Environment) in which contracts formed between two or more parties (users as physical or moral persons, service providers, . . . ) can be executed.

In the embodiment described here, the module GES-ECN for management of a digital trust environment of the server SDP for management of personal data is configured to dynamically administer in the network a variable number of instances ECNᵢ, ECNⱼ of the digital trust environment ECN as a function of the number of contracts to be executed.

In the embodiment described here, these instances ECNᵢ, ECNⱼ of the digital trust environment are cloned by the module GES-ECN. These cloned instances all comprise the same module EXEC-CONT for executing a contract and the same pair of keys comprising a public key KPUB_{ECN} and an associated private key KPRIV_{ECN} stored in a rewritable non-volatile memory M_{ECN}.

In the embodiment described here, the terminal T_{A} is a mobile phone.

In this example it is assumed that the user A has downloaded and installed in his terminal T_{A} an application APP with the server SDP for management of personal data, this application letting the user A access the services offered by the server, especially the historical data service HIST of personal data and the GES-CONT service for management of digital contracts.

The application APP comprises a cryptographic module MCY.

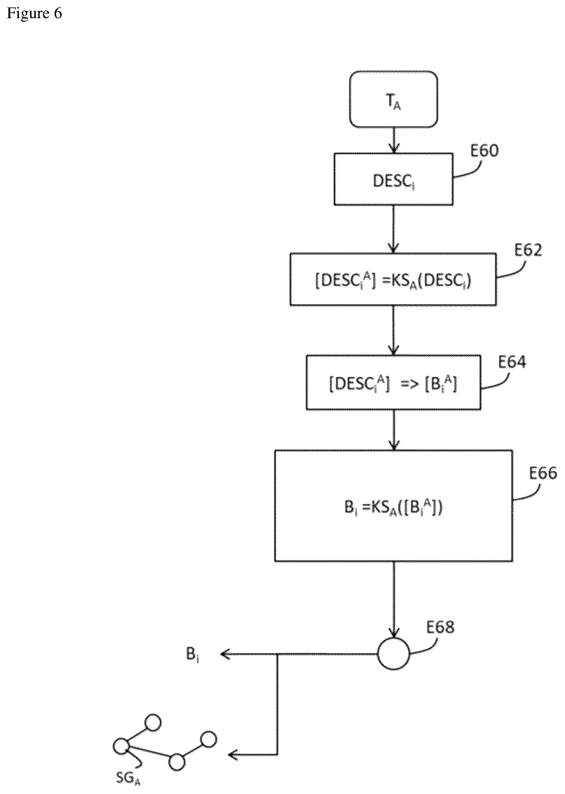

In the embodiment described here, it is assumed that the application APP also comprises a GEN-CONT module for generation of a contract letting the user of the terminal T_{A} form with one or more other parts of contracts intended to be executed in the digital trust environment ECN. These operations are detailed later in reference to FIG. 7.

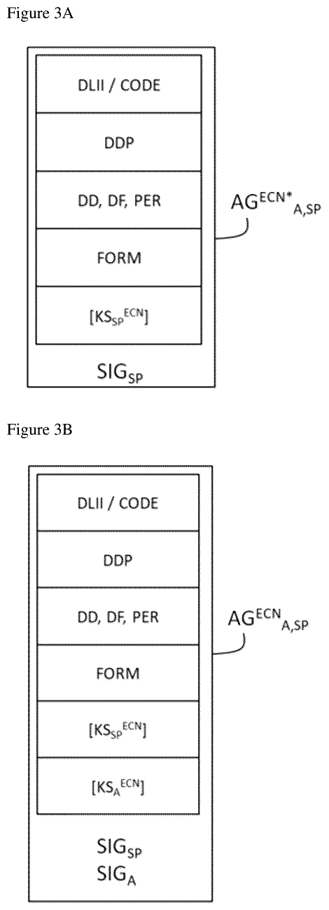

FIG. 1 illustrates the terminal T_{A} after the user A has opened an account via the server SDP for management of personal data to subscribe to the historical data service HIST of his personal data. Steps E40 to E45 performed by the terminal TA for opening this account will be described later in reference to FIG. 4. Following opening of this account, a rewritable non-volatile memory M_{A} of the terminal T_{A} comprises, in this example:
identifiers LOG/MP (login, password) to let user A access his account via the local application APP;
a pair of keys comprising a private key KPRIV_{A} and public key KPUB_{A};
a symmetric encryption key KS_{A}; and
a confidential unique identifier ID_{A}.

In the embodiment described here, the terminal T_{A} comprises a module MDD for detection of displacements of the terminal T_{A}.

In this example, the module for detection of displacements MDD comprises artificial intelligence IA, a GPS geolocation module and a detector of movement MVT comprising for example an accelerometer and a gyroscopic sensor for measuring the linear acceleration, the orientation and the angular speed of the terminal T_{A}.

This module for detection of displacement MDD is configured to generate timestamped personal geolocation data DP_{GEO}^{A} of the user A, these data comprising positions Pᵢ occupied by the terminal T_{A} in the real world on dates Tᵢ.

In the embodiment described here, the terminal T_{A} also comprises a camera CAM and a payment application PAY. It is assumed that the photographs acquired by the camera CAM and that the transactions performed with the application PAY constitute personal data DP_{DigAct}^{A} of the user A representative of digital activities performed by the user A. Other digital activities are possible, for example the sending or receipt of messages (electronic mail, short texts, . . . ) executed with messaging applications of the terminal T_{A}, not shown.

In the embodiment described here, the terminal T_{A} is also configured to manage personal data DP_{3rdP}^{A} acquired from third parties, for example from an administrative service, a bank, insurance, a business, . . .

In general, the personal data of the user A will be denoted DP^{A}, those able for example to comprise, and in a non-limiting manner, personal geolocation data DP_{GEO}^{A}, personal data DP_{DigAct}^{A} representative of digital activities and personal data DP_{3rdP}^{A} acquired from third parties.

In the embodiment described here, the server SDP comprises a centralised general database BD_{C} which stores the history of the personal encrypted data of all users who have subscribed to the service HIST.

In the embodiment described here, the personal encrypted data of users are organised according to an n-dimensional blockchain.

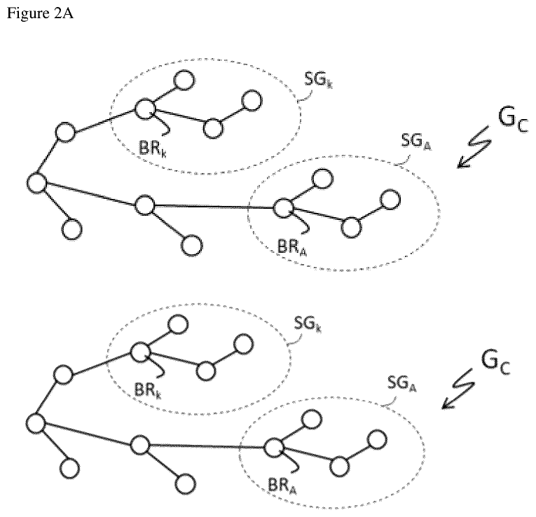

In the embodiment described here, this n-dimensional blockchain takes the form of a general direct acyclic graph G_{C} whereof the topology is defined by a preset data model which will be described hereinbelow in reference to FIGS. 2A and 2B.

This blockchain constitutes a distributed register which can be updated within a peer network.

In the embodiment described here, the terminal of a user who has subscribed to the historical data service HIST of his personal data is a pair of this network. By way of example, the terminal T_{A} locally maintains:
a local database BD_{A} comprising his own personal encrypted data; and
a copy of a sub-graph SG_{A} of the general graph G_{C} which comprises the history of his own encrypted personal data DP^{A}.

The terminal T_{A} can therefore work offline and asynchronously by exploiting the ownership of the graphs.

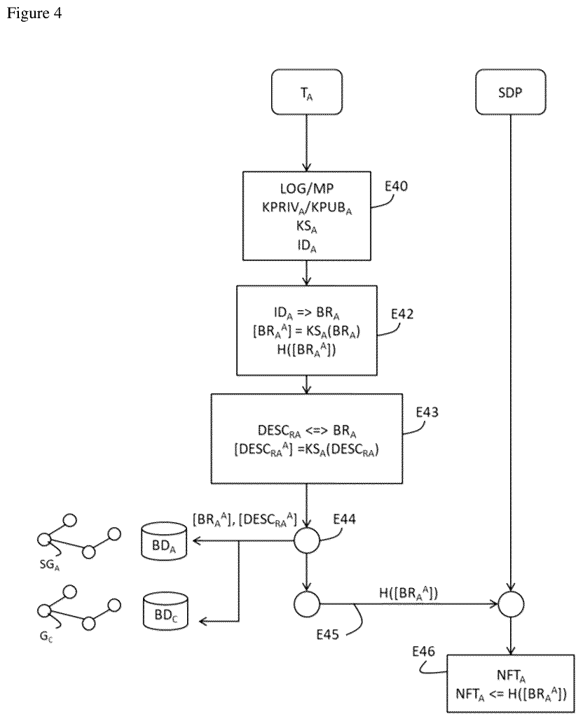

In this way, in the embodiment described here, and as described later in reference to FIG. 5, when the terminal T_{A} detects new personal data DP^{A} to be recorded, they are encrypted by the cryptographic module MCY of the terminal T_{A}, stored in the local database BDA of the terminal T_{A}, integrated by the terminal T_{A} into the sub-graph SG_{A} local at the terminal T_{A} before being synchronised, when a connection allows it, with the blockchain of the general graph G_{C}.

The synchronisation between the pairs is ensured by the general database BD_{C}. When a pair creates or receives a new block, it adds it to its copy of the register and then transmits it to its pair nodes. When the latter receive it, they verify that this new block is valid. If the block is valid, they integrate it on their register and transmit it in turn to their pairs.

FIG. 2A illustrates an example of general graph G_{C} representing the organisation of the personal encrypted data of all the users T_{A}, Tₖ of the historical data service HIST stored in the general database BD_{C} managed by the server SDP for management of personal data.

In the example illustrated here, the general graph G_{C} comprises especially a sub-graph SG_{A} which illustrates the organisation of encrypted personal data DP^{A} of the user A in the general database BD_{C} or in the local database BD_{A}, assuming these bases are synchronised. As mentioned previously, the topology of the general graph G_{C} (and therefore in particular of the sub-graph SG_{A}) is defined by a preset data model.

FIG. 2B illustrates more precisely the sub-graph SG_{A} which illustrates the organisation of the encrypted personal data DP^{A} of the user A in keeping with a particular data model. In the particular case of this data model, the sub-graph SG_{A} is a direct acyclic graph. It comprises especially a root BR_{A} and a set of branches constituted by blocks interconnected by arcs.

In the embodiment described here, the module for detection of displacements MDD of the terminal T_{A} is configured to detect a type of displacement of the terminal T_{A} in the real world, for example travel by car or travel by foot.

In the exemplary embodiment described here, and as per the preset data model, the sub-graph of personal data of a user comprises especially a branch for each of the detected displacements of this user.

For example, in FIG. 2B:
each of the branches F1 to F3 comprises encrypted blocks comprising timestamped personal geolocation data DP_{GEO}^{A} acquired during a car trip detected by the terminal T_{A};
each of the branches F4 to F5 comprises encrypted blocks comprising timestamped personal geolocation data DP_{GEO}^{A} acquired during a walking trip detected by the terminal TA.

This example is non-limiting, and other types of travel not shown are possible.

As shown more precisely for the branch F5, each branch associated with a displacement comprises a set of blocks, each block Bᵢ comprising an encrypted geolocation Pᵢ and a date Tᵢ, which indicate that during displacement associated with this branch F5 the terminal T_{A} was located at the position Pᵢ at the instant Tᵢ.

When the module for detection of displacements MDD detects that a journey is completed, for example, when the position of the terminal T_{A} is detected unchanged over a predetermined period, the branch stops. If a new displacement is detected, a new branch is created.

The example in FIG. 2B shows in greater detail three blocks Bᵢ₋₁, Bi, Bᵢ₊₁ comprising positions Pᵢ₋₁, Pi , Pᵢ₊₁ at successive times Tᵢ₋₁, Tᵢ, Tᵢ₊₁ of the terminal T_{A} during a journey on foot. Note that, in accordance with the blockchain mechanism, each block Bi includes, in addition to its own encrypted data, an output hash H([Bᵢ₋₁^{A}]) of the preceding block. This characteristic of hash functions means that any change to the contents of a block is immediately visible in subsequent blocks.

In line with the particular data model described here, the branches associated with detected displacements of the terminal of a user constitute the principal skeleton of the sub-graph of a user.

In the embodiment described here, the sub-graph SG_{A} can also comprise blocks comprising encrypted personal data DP_{DigAct}^{A} of the user A acquired during digital activities performed by the terminal T_{A}.

In the embodiment described here, the sub-graph SG_{A} can also comprise blocks comprising encrypted personal data DP_{3rdP}^{A} of the user A acquired from third parties.

In the embodiment described here, a block comprising data associated with a digital activity or received from a third party on a given date is attached in the sub-graph SG_{A} to a block comprising this date and the geolocation of the terminal T_{A} on this date.

In this way, by way of example, FIG. 2B shows:
a node Bₖ comprising an encrypted photograph PIX acquired by the camera CAM at the instant Tᵢ₋₁ while the terminal was at the position Pᵢ₋₁;
a node Bᵣ comprising an encrypted contract AG received from a third party at the instant Tᵢ₊₁ when the terminal was at the position Pᵢ₊₁.

This sub-graph evolves dynamically, growing richer from the personal data of the user.

Highly advantageously, the sub-graph SG_{A} of the blockchain comprising the personal data DP^{A} of a user A ensures the immutability of the history of these data and their authenticity when they are validated by an external third party of trust.

As is known to the skilled person, to give the graph its probative value it is necessary, for example at regular intervals, to integrate therein data produced by an external third party of trust (for example another blockchain). For example, the terminals can transmit the hash of the last block of the graph to this third party of trust, the third party of trust produces information from this hash, and this information signed by the third party of trust is integrated into the graph.

In a particular embodiment, the history of the personal data of a user is attached by the server SDP for management of personal data to a dynamic non-fungible token.

For example, and as described later, in reference to FIG. 4, an output hash of the root block of the sub-graph of history data of a user can be associated by the server SDP with a cryptographic datum (for example a dynamic non-fungible token or the public key of a digital wallet) attributed by this server to this user.

An embodiment of the invention is described hereinbelow in which the cryptographic datum specific to the user is a non-fungible token NFT_{A}, the invention accordingly letting the user attach his history of personal data to his dynamic non-fungible token NFT_{A}.

In a particular embodiment of the invention, the user A, owner of the dynamic non-fungible token NFT_{A} can generate at least one second non-fungible token NFT_{A}² and associate a sub-graph of his sub-graph SG_{A} to this second non-fungible token.

It is now assumed that the user A and the service provider SP have subscribed to the GES-CONT service for management of digital contracts and that they want to set up a digital contract AG^{ECN}_{A,SP} intended to be executed by an instance ECNᵢ of the digital trust environment ECN so as not to expose the personal data of the parties to the contract during execution of the contract.

It is assumed that the terminal T_{SP} of the service provider SP has downloaded an application GEN-CONT for generation of a contract from the server SDP, compatible with that of the application APP downloaded by the terminal T_{A}.

It is assumed that a user of the terminal SDP has used the application GEN-CONT to open an account with the server SDP for management of personal data to subscribe to the GES-CONT service for management of contract

Following opening of this account, a rewritable non-volatile memory M_{SP} of the terminal T_{SP} comprises, in this example:
identifiers LOG/MP (login, password) to let the user access his account via the local application GEN-CONT;
a pair of keys comprising a private key KPRIV_{SP} and public key KPUB_{SP};
a symmetric encryption key KS_{SP}; and
a confidential unique identifier ID_{SP}.

In the embodiment described here, the service provider SP uses his application GEN-CONT to set up a contract proposal noted AG^{ECN*}_{A,SP}. In the embodiment described here, the analyses to be performed on the data of the user, their frequency, the length of the contract, the format of the results, the rules of dissemination of the result are described explicitly in the contract proposal.

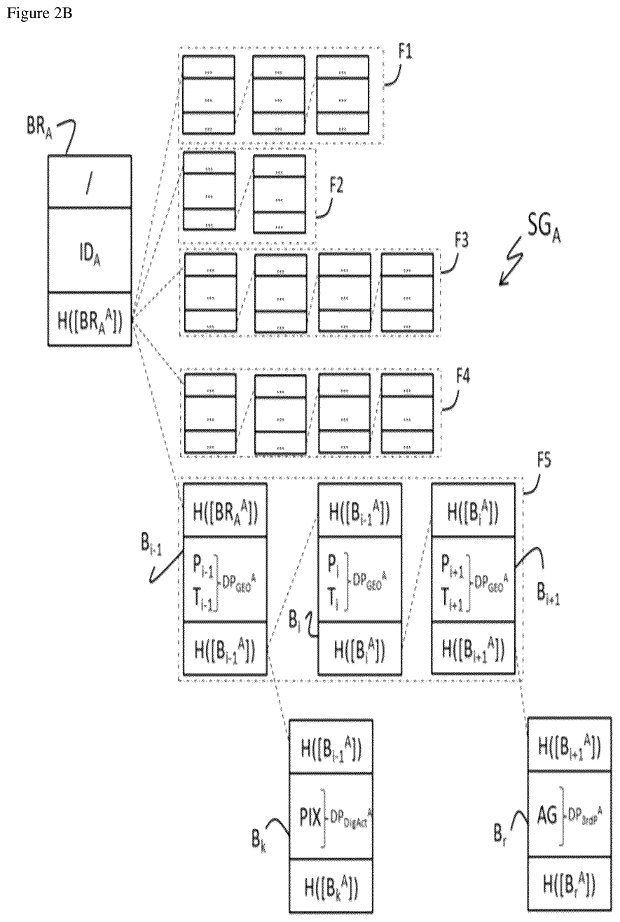

An example of contract proposal AG^{ECN*}_{A, SP} is shown in FIG. 3A. This proposal comprises:
a literal interpretable description DLII by an instance ECNᵢ of the digital trust environment ECN and/or a code CODE executable by this instance ECNᵢ to perform analyses on personal data DP^{A} of A;
a description DDP of the personal data DP^{A} of A to which the digital trust environment ECN must refer this analysis, for example the category of personal data (timestamped data of geolocation, photographs, messages, . . . ) and the relevant time range (personal data detected between this date and that date . . . )
the start date DD, the finish date DF and a periodicity PER of execution of the contract;
a format FORM in which the digital trust environment must return the result of analyses to the different parties A, SP;
the encryption key KS_{SP} of the party SP encrypted with the public key KPUB_{ECN} common to the instances ECNᵢ of the digital trust environment configured to execute the contract; and
a signature SIG_{SP} of this contract proposal with the private key KPRIV_{SP} of the service provider.

The encryption key KS_{SP} encrypted with the public key KPUB_{ECN} is noted [KS_{SP}^{ECN}].

When the terminal T_{A} obtains this encrypted contract proposal, it verifies the signature SIG_{SP} with the public key KPUB_{SP} of the service provider SP.

If the user A of the terminal T_{A} accepts the contract proposal, he inserts his encryption key KS_{A} encrypted with the public key KPUB_{ECN} common to the instances ECNᵢ of the digital trust environment, signs this proposal completed with his private key KPRIV_{A}, and inserts his signature SIG_{A} into the contract proposal to form the contract AG^{ECN}_{A, SP}. The encryption key KS_{A} encrypted with the public key KPUB_{ECN} is noted [KS_{A}^{ECN}].

The contract AG^{ECN}_{A, SP} formed in this way is shown in FIG. 3B. It integrates delegations to the personal encrypted data of the parties A and SP for exclusive use of the instances ECNᵢ of the digital trust environment ECN in which these data are analysed.

In the embodiment described here, the contract AG^{ECN}_{A, SP} is signed with the public keys KPUB_{A}, KPUB_{SP} of the parties A and SP to the contract, and with the public key KPUB_{ECN} common to all the instances ECNᵢ of the digital trust environment. Each of the parties A and SP and any instance ECNᵢ of the digital trust environment ECN can decrypt the contract by using its sole private key.

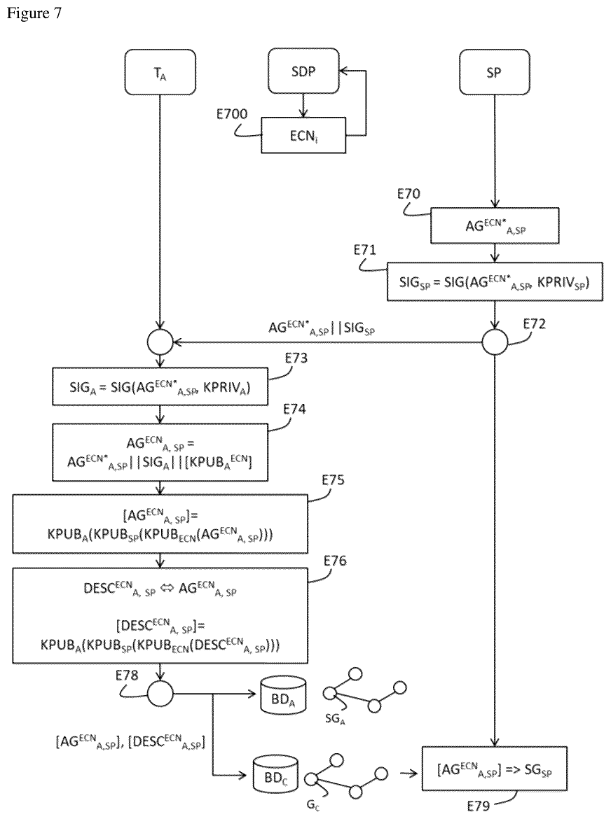

The execution of the contract by an instance of the digital trust environment is described in reference to FIG. 8.

FIG. 4 illustrates the main steps performed in a particular embodiment of the invention to set up the account of a user and attribute a dynamic non-fungible token for him. By way of illustration, the creation of the account of a user A from his terminal T_{A} and the creation of his non-fungible token NFT_{A} by the server SDP for management of personal data will be considered.

The invention can be transposed directly to other embodiments in which the cryptographic datum specific to the user is not a dynamic non-fungible token, especially when it is constituted by a public key of a digital wallet.

During a step E40, the user A of the terminal T_{A} creates his account with the historical data service HIST of personal data provided by the server SDP. In the embodiment described here, to this effect the user A utilises a local application APP previously downloaded via his terminal T_{A} from the server SDP for management of personal data, to obtain and register in the memory M_{A} of the terminal T_{A}:
identifiers LOG/MP (login, password) to access his account via the local application APP;
a pair of keys comprising a private key KPRIV_{A} and public key KPUB_{A};
a symmetric encryption key KS_{A}; and
a confidential unique identifier ID_{A}.

These elements (identifiers, pair of keys, symmetric encryption key, unique identifier) are preferably generated by the terminal T_{A}, for example by the local application APP.

They are preferably stored in a memory M_{A} of the terminal T_{A}.

During a step E42, the terminal T_{A} integrates its confidential unique identifier IDA into the root block BR_{A} of its structure of data SG_{A}, and encrypts the root block BR_{A} with its symmetric encryption key KS_{A}. This block of encrypted data is noted H[BR_{A}^{A}]. An output hash H([BR_{A}^{A}]) of the root block is calculated by applying the hash function H to the block of encrypted data [BR_{A}^{A}].

During a step E43, the root block BR_{A} is associated with a descriptor DESC_{RA} of this block, also encrypted with the symmetric encryption key KS_{A} of the terminal T_{A}. This encrypted descriptor is noted [DESC_{RA}^{A}].

The descriptor DESC_{RA} of the root block BR_{A} is for example the chain of characters ‘Block root’. This descriptor lets anyone who has the symmetric encryption key KS_{A} to find the root block BR_{A} of the structure of data of the user A.

The choice of the descriptor can be any. But in a preferred embodiment of the invention the choice of the descriptor is defined in the preset data model. This model contains for example a convention on the descriptors to be used.

In the embodiment described here the root block comprises no hash connecting it to one or more previous blocks of data.

During a step E44, the encrypted root block [BR_{A}^{A}] is stored in the local databases BDA of the terminal T_{A} in association with its encrypted descriptor [DESC_{RA}^{A}]. The encrypted root block [BR_{A}], and its associated encrypted descriptor [DESC_{RA}^{A}] are sent to the server SDP when a connection network is available. They are recorded in the general database BD_{C} and the encrypted root block [BR_{A}] is synchronised with the general graph G_{C}.

During a step E45, the terminal T_{A} transmits the hash H([BR_{A}^{A}]) output of the root block BR_{A} of its graph SG_{A} to the server SDP for management of personal data.

During a step E46, the server SDP for management of personal data creates a dynamic non-fungible token NFT_{A} whereof it accords ownership to the user A and it associates the output hash H([BR_{A}^{A}]) of the root block to this non-fungible token NFT_{A}.

It is clear that the output hash H([BR_{A}^{A}]) cannot be found in the different encrypted blocks and therefore cannot be associated with the data of the user A other than to keep the symmetric encryption key KS_{A} of this user.

FIG. 5 illustrates the main steps performed for constitution of the history of personal data DP^{A} of a user, for example for those of the user A. In the embodiment described here, the data can be any type. They can for example be declarative data, or assorted data of elements of proof, for example of a digital signature, or secure integrated links.

As mentioned previously, these personal data DP^{A} can be timestamped personal data DP_{GEO}^{A} of geolocation of the terminal T_{A}, acquired during detected displacements of the terminal TA, for example during mobility activities (walking, biking, running, car travel, . . . ). Such data comprise for example GPS positions Pᵢ₋₁, Pᵢ, Pᵢ₊₁ at successive instants Tᵢ₋₁, Tᵢ, Tᵢ₊₁ of the terminal T_{A} during displacement.

As mentioned previously, these personal data DP^{A} can be personal data DP_{DigAct}^{A} corresponding to digital activities performed on the terminal T_{A}, for example the taking of a photograph or a video, a message exchange, an interaction with an application of the terminal T_{A}.

As mentioned previously, these personal data DP^{A} can be personal data DP_{3rdP}^{A} acquired from third parties, for example an administrative service, a bank, insurance, a business, . . .

In the embodiment described here the personal data DP^{A} of the user A are integrated automatically into the history of the user as soon as they are detected by the terminal T_{A}. As a variant, at least some data are integrated only on express authorisation of the user on his terminal.

It is assumed that during a step E50 the terminal T_{A} detects a personal datum DP^{A} to be integrated into the history of the personal data of the user A.

During a step E52, the personal datum DP^{A} is integrated into a block Bᵢ of the graph SG_{A}, the position of this block in the graph being defined by a preset data model.

As described previously in reference to FIG. 2, this block Bᵢ comprises:
except for the root block BR_{A}, the output hash Hₖ of each of the blocks Bₖ upstream of the block Bᵢ in the graph SG_{A}; and
the personal datum DPᵢ^{A}.

The terminal T_{A} encrypts the block Bᵢ with its symmetric encryption key KS_{A}. This block of encrypted data is noted [Bᵢ^{A}]. An output hash H([Bᵢ^{A}]) of the block Bᵢ is calculated by applying the hash function H to the block of encrypted data [Bᵢ^{A}].

During a step E54, the encrypted block Bᵢ is associated with a descriptor DESCᵢ of this block, for example selected in keeping with the convention of the preset data model. This descriptor DESCᵢ is also encrypted with the symmetric encryption key KS_{A} of the terminal TA. This encrypted descriptor is noted [DESCᵢ^{A}].

For example:
the descriptor DESCᵢ associated with a block of data Bᵢ comprising timestamped personal data DP_{GEO}^{A} of geolocation of the terminal T_{A}, acquired during car travel of the terminal T_{A} on Jun. 4, 2021 can be the chain of characters ‘2021 Jun. 4∥By car;
the descriptor DESCᵢ associated with a block of data Bᵢ comprising personal data DP_{DigAct}^{A} corresponding to digital activity of the terminal T_{A} on 27 Jul. 2021 can be the chain of characters ‘2021 Jul. 27∥photo’ or ‘2021 Jul. 27∥mail’;
the descriptor DESCᵢ associated with a block of data Bᵢ comprising personal data DP_{3rdP}^{A} acquired from third parties by the terminal T_{A} on Aug. 4, 2022 can be the chain of characters ‘2022 Apr. 8∥bank’.

During a step E56, the block of encrypted data [Bᵢ^{A}] is stored in the local databases BDA of the terminal T_{A} in association with the encrypted descriptor [DESCᵢ^{A}]. The block of encrypted data [Bᵢ^{A}], associated with the encrypted descriptor [DESCᵢ^{A}] is synchronised with the general graph G_{C} when a network connection is available.

It is evident that the entire graph SG_{A} representative of the history of the personal data of the user A does not have to be stored permanently on the terminal T_{A}. Regular updating of a collection of blocks in the local database BDA of the terminal T_{A} can be defined for example by the data model and by the current state of the graph. The strategy of conservation of a partial history on the terminal T_{A} can depend on functional choices (data necessary for functioning and constitution of a non-repudiable history) and performance (latency access blocks in the local database vs. online access).

The constitution and consultation of the history of personal data DP^{A} by the terminal T_{A} can be done asynchronously, off-network, and be resynchronised without degradation of the functionalities and security of the solution.

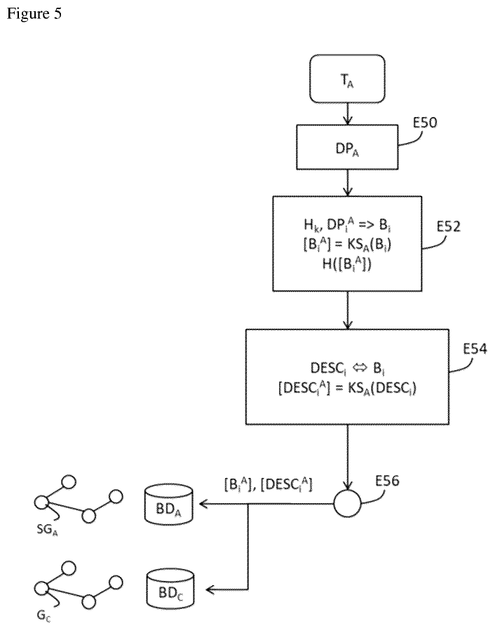

FIG. 6 illustrates the main steps performed by the terminal of a user for consultation of personal data of this user. By way of example the steps performed by the terminal T_{A} of the user A are detailed for consultation of personal data DP^{A} of this user. As a reminder any encrypted block [Bᵢ^{A}] recorded in the blockchain, encrypted by a symmetric key KS_{A}, is associated with a descriptor [DESCᵢ^{A}] of this block, also encrypted with this same symmetric encryption key KS_{A}.

Inversely, access to a block of data Bᵢ is done from the associated descriptor DESCᵢ. It can be assumed that user A wants to consult the blocks associated with a descriptor DESCᵢ, for example constituted by the chain of characters ‘2021 Jun. 4∥By car. During a step E60, the user selects a descriptor in keeping with the convention of the preset data model. During a step E62, this descriptor DESCᵢ is encrypted with the symmetric key KS_{A} of the user to produce an encrypted descriptor [DESCᵢ^{A}].

During a step E64, the encrypted blocks [Bᵢ^{A}] corresponding to the encrypted descriptor [DESCᵢ^{A}] are identified.

During a step E66, the encrypted blocks [Bᵢ^{A}] identified with the preceding step (E64) are decrypted with the symmetric key KS_{A} of the terminal T_{A} to produce the decrypted blocks Bᵢ.

According to the needs of the user, the content of the decrypted blocks Bᵢ can be presented to the user A during a step E68. The graph SG_{A} of personal data DP^{A} can be reconstituted by using the hierarchy (father-son links) between the blocks of the graph SG_{A}, this hierarchy able to be deduced from the hashes contained in the blocks of data.

It is noted that the structure of the sub-graph SG_{A} can appear before or advantageously after decryption of the personal data DP^{A}.

The entire graph SG_{A} can be verified by the terminal T_{A}.

FIG. 7 illustrates the main steps performed for setting up a contract between at least two parties. By way of example, the setting up a contract AG^{ECN}_{A, SP} between a user A and a service provider SP can be considered, who wants to carry out analyses on the personal data DP^{A} of A, this contract being intended to be executed in a digital trust environment ECN.

In the embodiment described here, during a general step E700, the server SDP for management of personal data manages a set of instances ECNᵢ, ECNⱼ of the digital trust environment cloned together. As described previously, these instances all comprise the same module EXEC-CONT for executing a contract and the same pair of public key KPUB_{ECN}, private key KPRIV_{ECN}. In the embodiment described here instances are created or destroyed as a function of the number of contracts recorded in the general graph G_{C}.

During a step E70, the party SP prepares a contract proposal AG^{ECN*}_{A, SP} between party SP and party A.

This contract proposal AG^{ECN*}_{A, SP} comprises, as shown in FIG. 3A:
a literal description interpretable by an instance ECNᵢ of the digital trust environment ECN and/or a code CODE which will be executed by this instance ECNᵢ to perform analyses on personal data DP^{A} of A;
a literal description DLII interpretable by an instance ECNᵢ of the digital trust environment

ECN and/or a code CODE executable by this instance ECNᵢ to perform analyses on personal data DP^{A} of A;
a description DDP of personal data DP^{A} of A on which the digital trust environment ECN must focus this analyse, for example the category of personal data (timestamped data of geolocation, photographs, messages, . . . ) and the range of relevant times (personal data detected between this date and that date . . . )
the start date DD, the finish date DF and a periodicity PER of execution of the contract;
a format FORM in which the digital trust environment must return the result of analyses to the different parties A, SP;
the encryption key KS_{SP} of the party SP encrypted with the public key KPUB_{ECN} common to the instances ECNᵢ of the digital trust environment configured to execute the contract.

During a step E71, the party SP signs the contract proposal AG^{ECN*}_{A, SP} with its private key KPRIV_{SP}. This signature is noted SIG_{SP}.

During a step E72, the party SP transmits the contract proposal AG^{ECN*}_{A, SP} and the signature SIG_{SP} to the party A.

If the party A accepts the contract proposal AG^{ECN*}_{A, SP}, during a step E73, the terminal T_{A} signs the contract proposal AG^{ECN*}_{A, SP}, with the private key KPRIV_{A} of A. This signature is noted SIG_{A}.

During a step E74, the terminal T_{A} inserts this signature SIG_{A} into the contract proposal AG^{ECN*}_{A, SP} as well as its public KPUB_{A} encrypted with the public key KPUB_{ECN} common to the different instances ECNᵢ of the digital trust environment. The public key KPUB_{A} encrypted with the public key KPUB_{ECN} is noted [KPUB_{A}^{ECN}].

The contract proposal AG^{ECN*}_{A, SP} initiated by the party SP and accordingly accepted by the party A can then be qualified by contract AG^{ECN}_{A, SP} formed between the parties A and SP. During a step E75, the contract AG^{ECN}_{A, SP} comprising the two signatures SIG_{SP}, SIG_{A} is encrypted asymmetrically with the public keys KPUB_{A}, KPUB_{SP} of the parties A and SP and with the public key KPUB_{ECN} common to the different instances ECNᵢ of the digital trust environment. The contract encrypted in this way is noted [AG^{ECN}_{A, SP}].

During a step E76, the contract AG^{ECN}_{A, SP} is associated with a descriptor DESC^{ECN}_{A, SP}, for example the chain of characters ‘Contract between A and SP’. This descriptor DESC^{ECN}_{A, SP} is encrypted with the public keys KPUB_{A}, KPUB_{SP} of the parties A, SP and with the public key KPUB_{ECN} common to the different instances ECNᵢ of the digital trust environment. The descriptor encrypted in this way is noted [DESC^{ECN}_{A, SP}].

Each of the parties A and SP and any instance ECNᵢ of the digital trust environment ECN can therefore decrypt the contract by using its sole private key KPRIV_{A}, KPRIV_{SP}, KPRIV_{ECN}.

During a step E78, the encrypted contract [AG^{ECN}_{A, SP}] and its encrypted descriptor [DESC^{ECN}_{A, SP}] are integrated into the graph SG_{A} of the user A and the general graph G_{C}. The encrypted contract [AGE^{CN}_{A, SP}] is indistinguishable in the general graph G_{C}.

In the embodiment described here, the server SP is notified (E79) that the encrypted contract [AG^{ECN}_{A, SP}] is available in the general graph GC and that this contract has been incorporated into the graph SG_{SP} of this server.

FIG. 8 illustrates the main steps performed for execution of a contract in keeping with a particular embodiment of the invention. By way of example the execution of a contract AG^{ECN}_{A, SP} drawn up between a user A and a service provider SP will be considered, this contract being intended to be executed by an instance ECNᵢ of a digital trust environment.

As mentioned previously, the encrypted contracts are recorded in the graphs SG_{A}, SG_{SP} of the users A, SP, . . . and in the general graph G_{C}.

In an embodiment of the invention, it is the users who verify whether contracts appear in their graph SG_{A}, SG_{SP} or in the general graph G_{C}. For this, and as described previously in reference to FIG. 6, they use the descriptors for identifying the contracts in the blockchain, for example the descriptors constituted by the chain of character ‘Contract’.

As a variant, it is the instances ECNᵢ of the digital trust environment which make these verifications in the general graph G_{C}.

During a step E80 which is repeated for example at regular intervals, the terminal T_{A} searches, from their descriptors, for encrypted contracts [AG] appearing in its graph SG_{A} or in the general graph G_{C}.

If the terminal T_{A} identifies an encrypted contract [AG^{ECN}_{A, SP}], it deciphers it with its private key KPRIV_{A} during a step E81.

During a step E82, the terminal T_{A} determines from the start date DD of the contract, the finish date DF of the contract and the periodicity PER of the contract whether execution of the contract is scheduled. If this is the case, the terminal T_{A} notifies this at an instance ECNᵢ of the digital trust environment during a step E83. During a step E84, this one instance ECNᵢ of the digital trust environment obtains the encrypted contract [AG^{ECN}_{A, SP}] and decrypts it with its private key KPRIV_{ECN}.

As described previously in reference to FIG. 3B, the encrypted contract AG^{ECN}_{A, SP} comprises the symmetric encryption keys KS_{A}, KS_{SP} of each of the parties encrypted with the public key KPUB_{ECN} of the instance ECNᵢ (noted respectively [KS_{A}^{ECN}], [KS_{SP}^{ECN}]).

During a step E85, the instance ECNᵢ decrypts the encryption keys encrypted with its private key KPRIV_{ECN}, and obtains the encryption keys KS_{A}, KS_{SP} of each of the parties.

The contract is executed by the instance ECNᵢ of the digital trust environment according to the terms of the contract.

During a step E86, the instance ECNᵢ determines from the description DDP which of the personal data of the parties the analysis must focus on, then performs its analysis by interpreting the interpretable literal description DLII or by executing the code CODE included in the contract. During this analysis, the personal data of the necessary parties are decrypted by the instance ECNᵢ with the symmetric encryption keys of the parties.

By following the parentage links defined by the hashes of the blockchain for the sub-graph of a party, the instance ECNᵢ can verify whether the cryptographic datum specific to a user, for example the non-fungible token NFT_{A} associated with the root block BR_{A} of the sub-graph SG_{A} belongs to the user A (for example associated with the public key KPUB_{A} of the user A in a database) and reconstitute the entirety of the history of the personal data of this party and perform analysis on the personal data targeted by the description DDP.

During a step E87, the instance ECNᵢ formats the result RES of the analysis according to the format FORM defined in the contract. It encrypts this result with the public keys KPUB_{A}, KPUB_{SP} of the parties A, SP. The result encrypted in this way is noted [RES].

During a step E88, the result RES is associated with a descriptor DESC_{RES}, for example the chain of characters ‘Result of execution of the Contract between A and SP’. This descriptor DESC_{RES} is encrypted with the public keys KPUB_{A}, KPU_{SP} of the parties A, SP. The descriptor encrypted in this way is noted [DESC_{RES}].

During a step E89, the encrypted result [RES] and its encrypted descriptor [DESC_{RES}] are integrated into the general graph G_{C} and synchronised with the sub-graphs SG_{A}, SG_{SP} of the parties to the contract, and the terminals of the parties are notified.

As described previously in reference to FIG. 4, when the user A of the terminal T_{A} creates his account with the historical data service HIST of personal data provided by the server SDP, the server SDP for management of personal data creates a cryptographic datum (for example a dynamic non-fungible token NFT_{A} or the public key of a digital wallet) whereof it ascribes ownership to the user A and it associates the history of the personal encrypted data with this cryptographic datum.

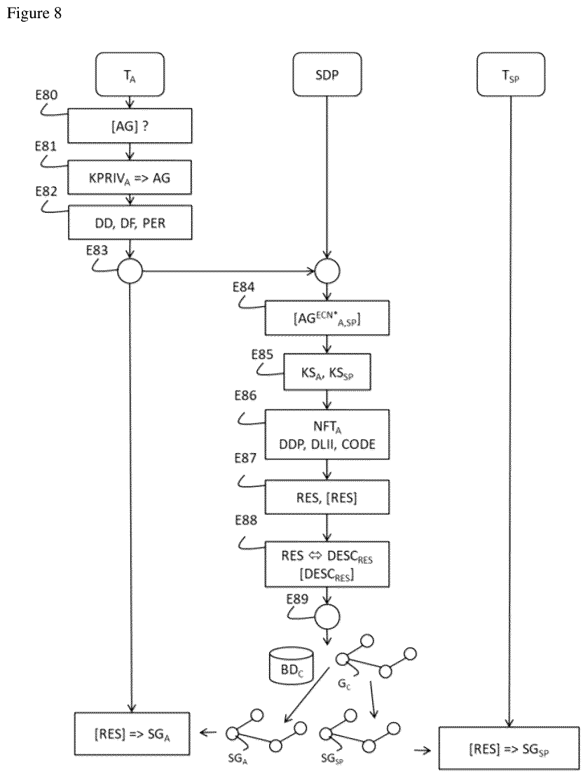

FIG. 9 presents the material architecture of a terminal in keeping with the invention. It comprises especially a processor 10, a read-only memory 11 (of ‘ROM’ type), a rewritable non-volatile memory 12 (of ‘EEPROM’ or ‘Flash NAND’ type for example), a rewritable volatile memory 13 (of type ‘RAM’), and a communication interface 14.

The read-only memory 11 constitutes a recording medium in keeping with an exemplary embodiment of the invention, legible by the processor 10 and on which a first computer program P1 is recorded in keeping with an exemplary embodiment of the invention. As a variant, the first computer program P1 is stored in the rewritable non-volatile memory 12.

The first computer program P1 allows the terminal to carry out a process for constitution of a history of personal data in keeping with the invention.

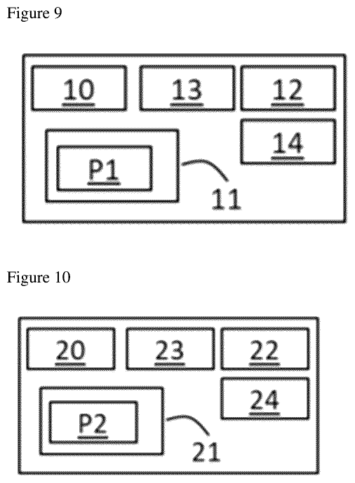

FIG. 10 presents the material architecture of a server for management of personal data in keeping with the invention. It comprises especially a processor 20, a read-only memory 21 (of type ‘ROM’), a rewritable non-volatile memory 22 (of type ‘EEPROM’ or ‘Flash NAND’ for example), a rewritable volatile memory 23 (of type ‘RAM’), and a communication interface 24.

The read-only memory 21 constitutes a recording medium in keeping with an exemplary embodiment of the invention, legible by the processor 20 and on which a second computer program P2 is recorded in keeping with an exemplary embodiment of the invention. As a variant, the second computer program P2 is stored in the rewritable non-volatile memory 12.

The second computer program P2 lets the server for management of personal data carry out a process for management of personal data of a plurality of users in keeping with the invention.

1. A process for constitution of a history of personal data of a user, this process being executed by a terminal of the user and comprising:
a step for obtaining a symmetric encryption key associated with a profile of the user;
a step for collecting personal data of the user;
throughout the collection of said personal data of the user:
(i) a step for encryption of these-said personal data with the symmetric encryption key (of this the user; and
(ii) a recording step, in a general database, of blocks comprising said encrypted data, said blocks being organised according to a blockchain constituting a sub-graph of a general graph whereof the topology is defined by a preset data model, a root block of said sub-graph being associated with a dynamic non-fungible token of this user.

2. The process for constitution of a history of personal data according to claim 1, wherein said blockchain is a distributed register within a peer network, said terminal being a peer of said network configured to store locally at least one part of said sub-graph, and said blocks being stored in a local database of said terminal.

3. The process for constitution of a history of personal data according to claim 1, wherein said data model defines how branches of said sub-graph comprise blocks whereof the personal encrypted data correspond to timestamped geolocation data of said terminal during detected displacement of said terminal.

4. The process for constitution of a history of personal data according to claim 3, wherein said data model defines how blocks whereof the personal encrypted data correspond to digital activity of the terminal on a given date or to data received from a third party on a given date is attached in said sub-graph to a block whereof the personal encrypted data correspond to geolocation data of said terminal timestamped on said given date.

5. The process for constitution of a history of personal data according to claim 1, said process comprising a step for integration in said sub-graph of a digital contract to which said user is party, said contract being encrypted by a public key of said terminal, a public key of at least one other party to the contract and a public key of a digital trust environment, said contract comprising at least:
the symmetric encryption key of the user encrypted with a public key of the digital trust environment; and
instructions able to be executed by said digital trust environment to:
(i) decrypt at least some of said personal data of said user with said symmetric encryption key;
(ii) verify that the non-fungible token associated with the root block of the sub-graph belongs to said user;
(iii) analyse said deciphered personal details; and
(iv) provide a result of said analysis to at least one party to the contract.

6. The constitution process of a history of personal data according to claim 1, comprising a step for generation of at least one second dynamic non-fungible token for said user and a step for association of a sub-graph of said sub-graph with a second dynamic non-fungible token.

7. A management process, executed by a server for management of personal data of a plurality of users, this process comprising the management of a general database in which blocks are recorded, each block comprising said personal encrypted data of a said user, said blocks comprising the personal encrypted data of the same user being organised according to a blockchain constituting a sub-graph of the same general graph whereof the topology is defined by a preset data model, a root block of said sub-graph being associated with a dynamic non-fungible token of this user.

8. The management process according to claim 7, said process comprising a step for management of a set of instances of a digital trust environment, a said instance being configured to:
execute instructions defined in a digital contract for analysing some of said personal data of at least one user party to the contract, said contract comprising a symmetric encryption key of said at least one party to the contract encrypted with a public key of said instance of digital trust environment, said symmetric encryption key able to be utilised by said instance to decrypt said personal data to be analysed; and
provide a result of said analysis to at least one party to the contract.

9. A terminal comprising a processor configured to perform:
a step for obtaining a symmetric encryption key associated with a profile of the user;
a step for collecting personal data of the user; and
throughout the collection of said personal data of the user:
(i) a step for encryption of these-the personal data with the symmetric encryption key of this the user; and
(ii) a recording step, in a general database, of blocks comprising said encrypted data, said blocks being organised according to a blockchain constituting a sub-graph of a general graph whereof the topology is defined by a preset data model, a root block of said sub-graph being associated with a dynamic non-fungible token of this user.

10. A server for management of personal data of a plurality of users, this server comprising a processor configured to manage a general database in which blocks are recorded, each block comprising said personal encrypted data of a said user, said blocks comprising the personal encrypted data of the same user being organised according to a blockchain constituting a sub-graph of the same general graph whereof the topology is defined by a preset data model, a root block of said sub-graph being associated with a dynamic non-fungible token of this user.

11. A computer program comprising instructions for the execution of a process for constitution of a history of personal data according to claim 1 when said program is run by a computer.

12. The computer program comprising instructions for the execution of a process for management of personal data of a plurality of users according to claim 7 when said program is run by a computer.
